(19) United States
(12) Patent Application Publication
(10) Pub. No.: US 2026/0194117 A1
(43) Pub. Date: Jul. 9, 2026

(54) BRAKE APPARATUS FOR VEHICLE

(71) Applicant: HYUNDAI MOBIS CO., LTD., Seoul (KR)

(72) Inventors: Sang Pil BOO, Yongin-si (KR); Kang Kuk LEE, Yongin-si (KR)

(73) Assignee: HYUNDAI MOBIS CO., LTD., Seoul (KR)

(21) Appl. No.: 19/416,976

(22) Filed: Dec. 11, 2025

(30) Foreign Application Priority Data
Jan. 3, 2025 (KR) 10-2025-0001125
Aug. 25, 2025 (KR) 10-2025-0118550

(51) Int. Cl. F16D 65/18; F16D 55/226; F16D 121/24; F16D 125/08; F16D 125/40

(52) U.S. Cl. CPC F16D 65/18; F16D 55/226; F16D 2121/24; F16D 2125/08; F16D 2125/40

(57) ABSTRACT

The present disclosure relates to a brake apparatus for a vehicle including: a caliper body provided with a cylinder; a nut screw rotatably disposed on the cylinder; a bolt screw movable in a first direction or in a second direction opposite to the first direction in conjunction with rotation of the nut screw; a piston movably disposed in the cylinder and configured to move in the first direction by pressing of the bolt screw and interfere with the bolt screw to restrict rotation of the bolt screw; a retainer secured to the cylinder and configured to interfere with the piston to restrict rotation of the piston; and a piston boot installed between the cylinder and the piston to prevent foreign substances from entering an interior of the cylinder, and integrally formed with the retainer.

### CROSS-REFERENCE TO RELATED APPLICATION

This application claims priority from and the benefit of Korean Patent Application No. 10-2025-0001125, filed on January 3, 2025, and Korean Patent Application No. 10-2025-0118550, filed on August 25, 2025, which are hereby incorporated by reference for all purposes as if set forth herein.

### BACKGROUND

### FIELD

Exemplary embodiments of the present disclosure relate to a brake apparatus for a vehicle, and more particularly, to a brake apparatus for a vehicle, which may ensure stable braking performance.

### DESCRIPTION OF THE RELATED ART

In general, a vehicle brake apparatus pushes a piston through driving force to bring a pad and a disc into close contact, and uses friction force between the pad and the disc to brake a vehicle.

Among vehicle brake apparatuses, an electro mechanical brake (EMB) does not use hydraulic pressure, but instead has a motor-driven actuator mounted on a caliper, pressing a piston to generate braking force through a mechanism that converts a rotational motion of a screw into a linear motion of a nut or converts a rotational motion of the nut into a linear motion of the screw.

The EMB is capable of active braking and independent braking for each wheel, thereby enabling not only general primary braking but also the implementation of each of the additional functions such as an anti-lock brake system (ABS), electric stability control (ESC), a traction control system (TCS), and automatic emergency braking (AEB); and the absence of hydraulic transmission delay enables higher performance.

In a conventional EMB, the number of components to be assembled is large, and there are also many components that need to be managed. Accordingly, an additional assembly process is required, which not only reduces production efficiency but also increases manufacturing costs and management burden.

In a conventional dry-type caliper that does not use hydraulic pressure, a watertight structure is generally not provided, such that moisture from the outside may enter an interior of a cylinder. Accordingly, external moisture such as rainwater or car wash water may enter the interior of the cylinder, potentially causing issues such as corrosion of an internal component, operational failure, and reduced braking performance.

The related art of the present disclosure is disclosed in Korean Patent Application Publication No. 10-2024-0054695 (published on April 26, 2024 and entitled “BRAKE APPARATUS FOR VEHICLE”).

### SUMMARY

Various aspects of the present disclosure provide a brake apparatus for a vehicle, which may ensure stable braking performance.

Various aspects of the present disclosure also provide a brake apparatus for a vehicle, which may prevent liquid or foreign substances from entering the interior of the cylinder.

A brake apparatus for a vehicle according to a first aspect of the present disclosure includes: a caliper body provided with a cylinder; a nut screw rotatably disposed in the cylinder; a bolt screw movable in a first direction or in a second direction opposite to the first direction in conjunction with rotation of the nut screw; a piston movably disposed in the cylinder and configured to move in the first direction by pressing of the bolt screw and interfere with the bolt screw to restrict rotation of the bolt screw; a retainer secured to the cylinder and configured to interfere with the piston to restrict rotation of the piston; and a piston boot installed between the cylinder and the piston to prevent foreign substances from entering an interior of the cylinder, and integrally formed with the retainer.

The piston may include: a piston body into which the bolt screw is inserted; a first interference portion provided on an inner peripheral surface of the piston body and configured to interfere with the bolt screw; and a second interference portion provided on an outer peripheral surface of the piston body and configured to interfere with the retainer.

The first interference portion may be formed to protrude from the inner peripheral surface of the piston body, and the second interference portion may be formed to be recessed in the outer peripheral surface of the piston body and extend along a direction of a central axis of the piston.

The bolt screw may include: a bolt body coupled to the nut screw by means of a ball member; a bolt head configured to press the piston body; and a third interference portion provided on an outer peripheral surface of the bolt head and capable of coming into contact with the first interference portion.

The third interference portion may be formed as a flat surface by cutting off a portion of the outer peripheral surface of the bolt head.

The retainer may include: a retainer body, in a ring shape, disposed between the cylinder and the piston; and a fourth interference portion provided on an inner peripheral surface of the retainer body and capable of coming into contact with the second interference portion.

The fourth interference portion may be formed to protrude from the inner peripheral surface of the retainer body.

The retainer may further include a damper coupled to the retainer body and capable of coming into contact with the piston.

The piston boot may be integrally formed with the damper.

The damper may further be provided with a projection portion seated on the piston.

A brake apparatus for a vehicle according to a second aspect of the present disclosure, the brake apparatus includes: a caliper body provided with a cylinder; a nut screw rotatably disposed in the cylinder; a bolt screw configured to reciprocate within the cylinder in conjunction with rotation of the nut screw; a piston movably disposed in the cylinder and configured to move by pressing of the bolt screw to move a brake pad toward a brake disc; and a piston boot disposed between the cylinder and the piston to prevent foreign substances or liquid from entering an interior of the cylinder, and interference-fit to each of the cylinder and the piston.

The piston boot may be formed in a ring shape, and the piston boot may include: an outer boot portion configured to accommodate a first metal insert, and interference-fit to an inner wall of the cylinder; an inner boot portion configured to accommodate a second metal insert, and interference-fit to an outer wall of the piston; and a connecting boot portion configured to connect the outer boot portion and the inner boot portion.

The outer boot portion, the inner boot portion, and the connecting boot portion may be integrally formed, and may be made of a rubber material.

The first metal insert may be inserted into and integrated with the outer boot portion by insert injection-molding, and the second metal insert may be inserted into and integrated with the inner boot portion by insert injection-molding.

The first metal insert and the second metal insert may be each formed in a ring shape, and a diameter of the first metal insert may be larger than a diameter of the second metal insert, and at least one of the first metal insert or the second metal insert may have a cross section formed in a rectangular shape or L-shape.

The connecting boot portion may have a cross-section formed in an accordion shape, and may be elastically deformable.

The brake apparatus may further include: a retainer secured to the cylinder and configured to interfere with the piston to restrict rotation of the piston, wherein the outer boot portion may be disposed such that an outer surface of the outer boot portion comes into contact with the inner wall of the cylinder, and a side surface of the outer boot portion comes into contact with the retainer.

The outer boot portion may be provided with one or more outer projections configured to protrude outward from a portion opposing the inner wall of the cylinder.

The inner boot portion may be provided with one or more inner projections configured to protrude inward from a portion opposing the outer wall of the piston.

In the present disclosure, the second interference portion formed on the piston may interfere with the fourth interference portion formed on the retainer, thereby preventing rotation of the piston; and the third interference portion formed on the bolt head may interfere with the first interference portion formed on the piston, thereby preventing rotation of the bolt screw.

In the present disclosure, elastic force of the projection portion formed on the damper may be applied to the piston toward a central portion of the piston, thereby maintaining centering of the piston.

According to the present disclosure, the piston boot may be integrally formed with the retainer, such that the piston boot and retainer may be unified into a single component, thereby enabling cost reduction and simplification of an assembly process.

According to the present disclosure, the piston boot may seal between the cylinder and the piston, thereby preventing liquid or foreign substances from entering the interior of the cylinder.

According to the present disclosure, the piston boot is press-fit to each of the cylinder and the piston, thereby enhancing sealing strength between the piston boot and the cylinder, and between the piston boot and the piston.

### BRIEF DESCRIPTION OF THE DRAWINGS

FIG. 1 is a perspective view of a brake apparatus for a vehicle according to a first embodiment of the present disclosure, when viewed from one direction.

FIG. 2 is a perspective view of FIG. 1, when viewed from another direction.

FIG. 3 is a cross-sectional view schematically showing the brake apparatus for a vehicle according to the first embodiment of the present disclosure.

FIG. 4 is a partially enlarged view of FIG. 3.

FIG. 5 is an exploded perspective view of the brake apparatus for a vehicle according to the first embodiment of the present disclosure, when viewed from one direction.

FIG. 6 is an exploded perspective view of FIG. 5 when viewed from another direction.

FIGS. 7 and 8 are partially enlarged cross-sectional views schematically showing an assembly process of the brake apparatus for a vehicle according to the first embodiment of the present disclosure.

FIG. 9 is a cross-sectional view schematically showing a brake apparatus for a vehicle according to a second embodiment of the present disclosure.

FIG. 10 is an enlarged view of section IV in FIG. 9.

FIG. 11 is a cross-sectional view showing a piston boot according to the second embodiment of the present disclosure.

FIG. 12 is a cross-sectional view showing a mounting process of the piston boot according to the second embodiment of the present disclosure.

FIG. 13 is an exploded perspective view showing the brake apparatus for a vehicle according to the second embodiment of the present disclosure.

FIG. 14 is a cross-sectional perspective view showing the piston boot according to the second embodiment of the present disclosure.

FIG. 15 is a cross-sectional view showing a first modification of the piston boot according to the second embodiment of the present disclosure.

FIG. 16 is a cross-sectional view showing a second modification of the piston boot according to the second embodiment of the present disclosure.

FIG. 17 is a cross-sectional view showing a third modification of the piston boot according to the second embodiment of the present disclosure.

### DETAILED DESCRIPTION OF THE ILLUSTRATED EMBODIMENTS

Hereinafter, a brake apparatus for a vehicle will be described with reference to the accompanying drawings through various embodiments. It should be considered that the thickness of lines or the size of components illustrated in the drawings may be exaggerated for clarity and convenience of description. In addition, the terms as used herein are defined in consideration of functions thereof in the present disclosure, and this may change depending on a user or operator’s intention or practice. Therefore, these terms should be defined based on the entirety of the disclosure set forth herein.

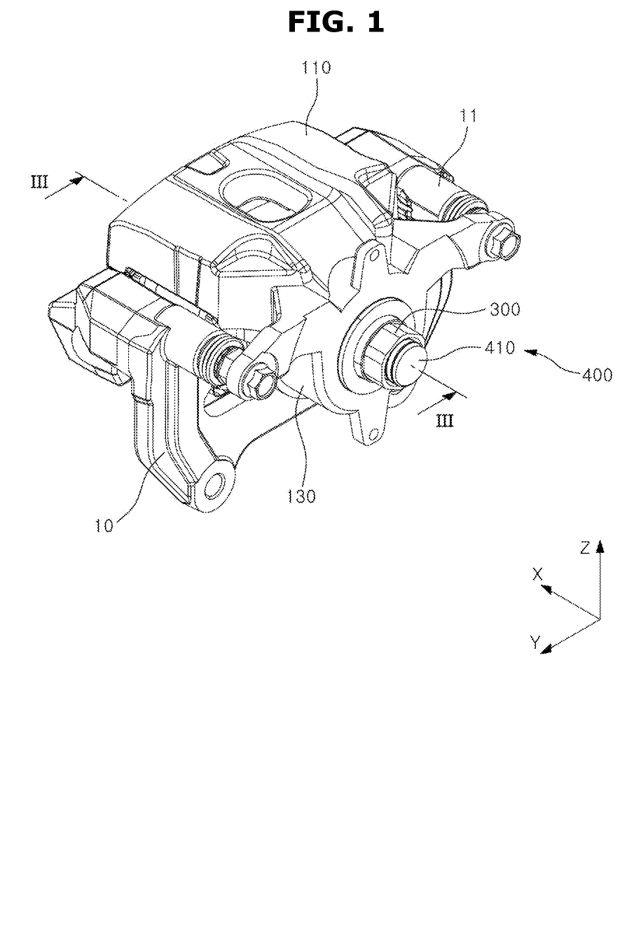

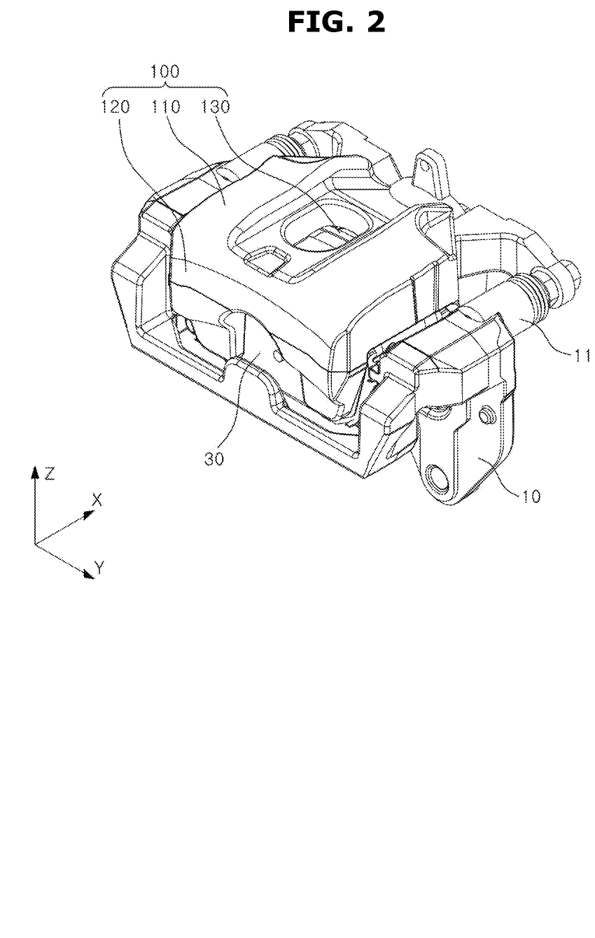

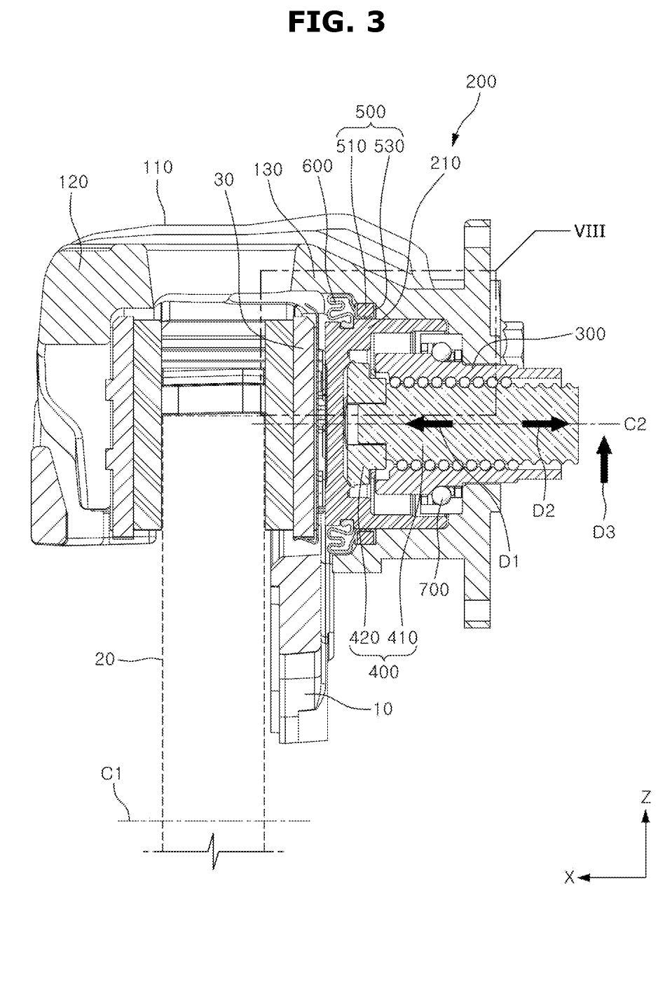

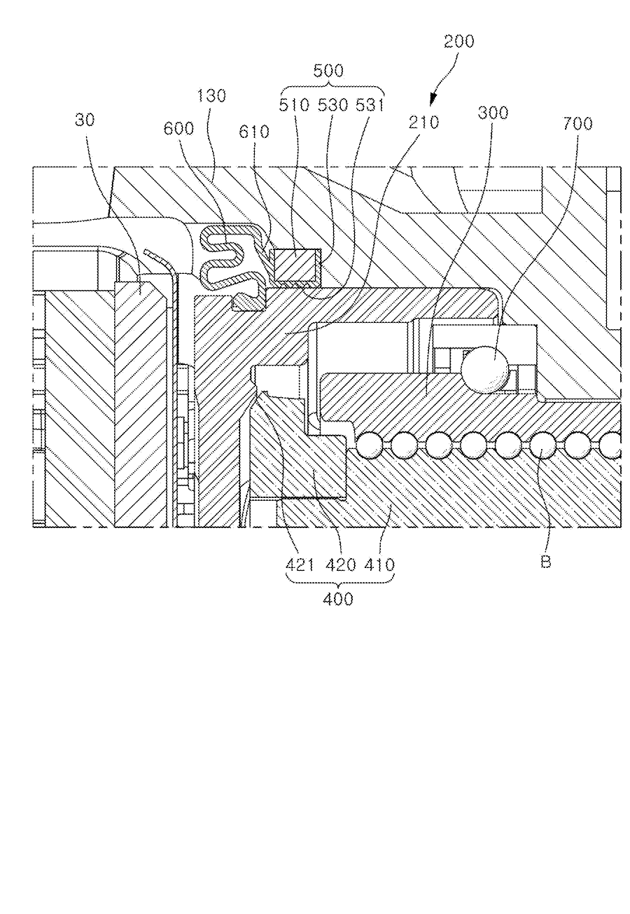

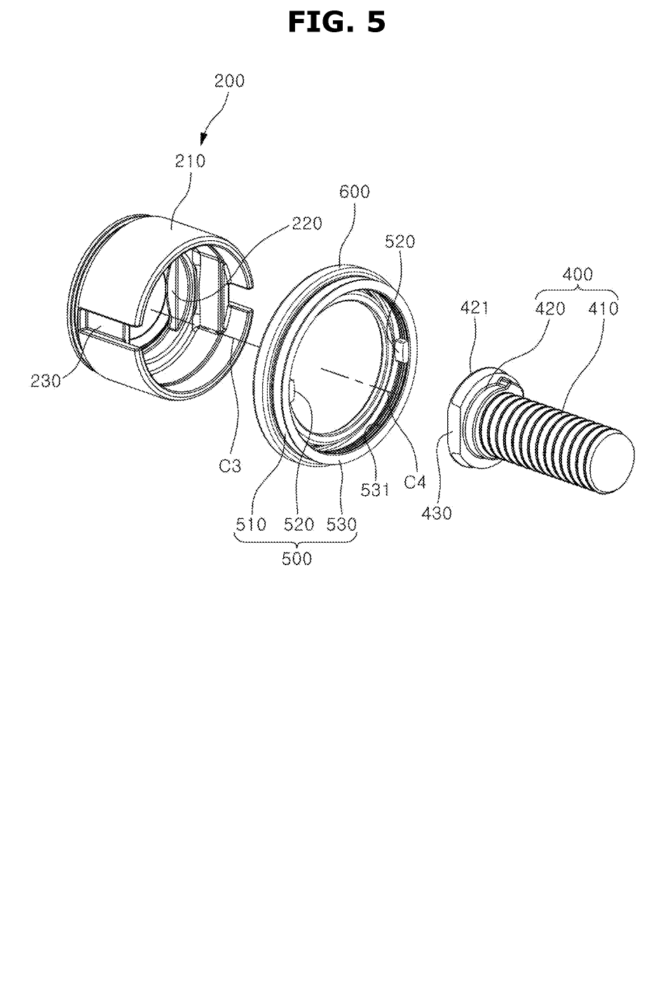

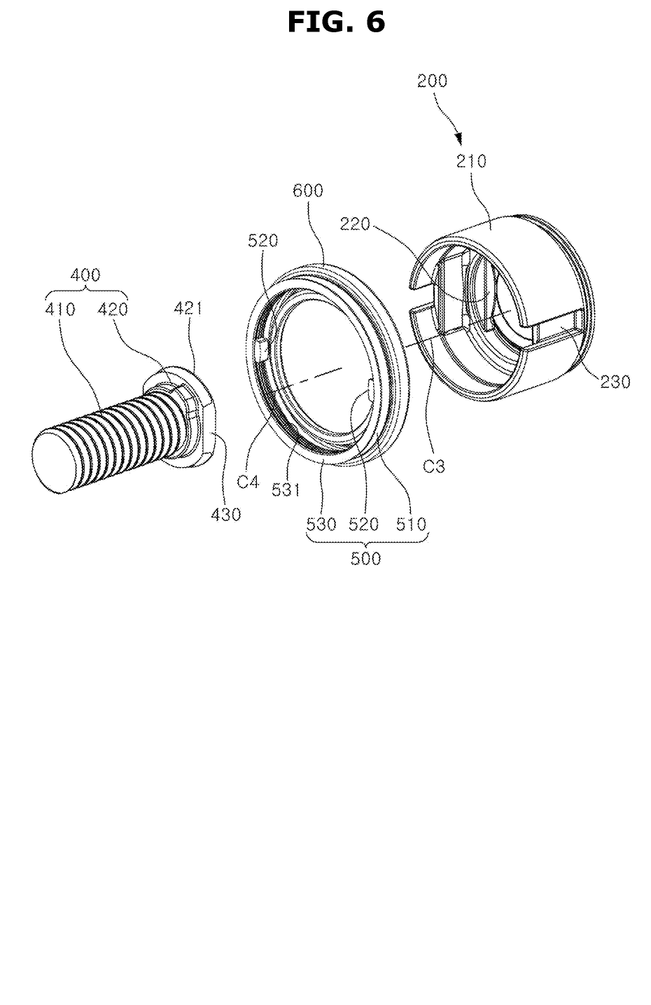

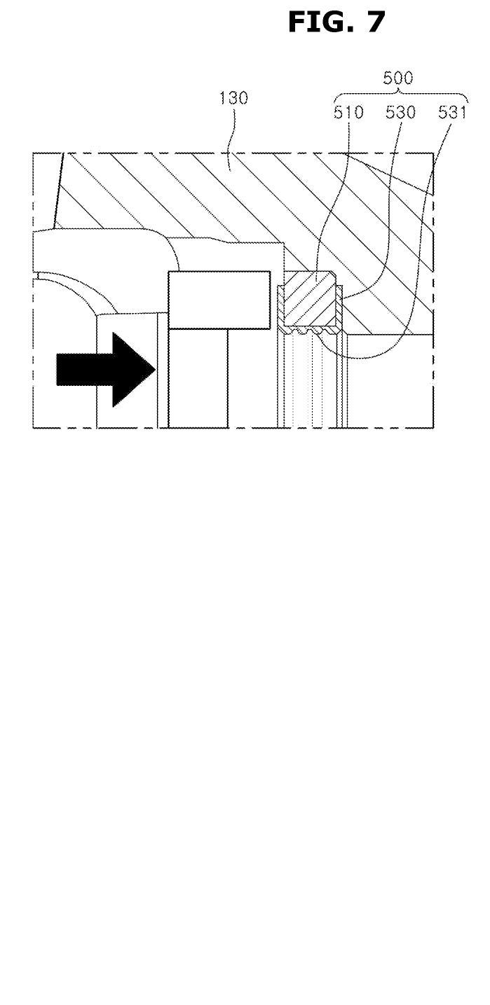

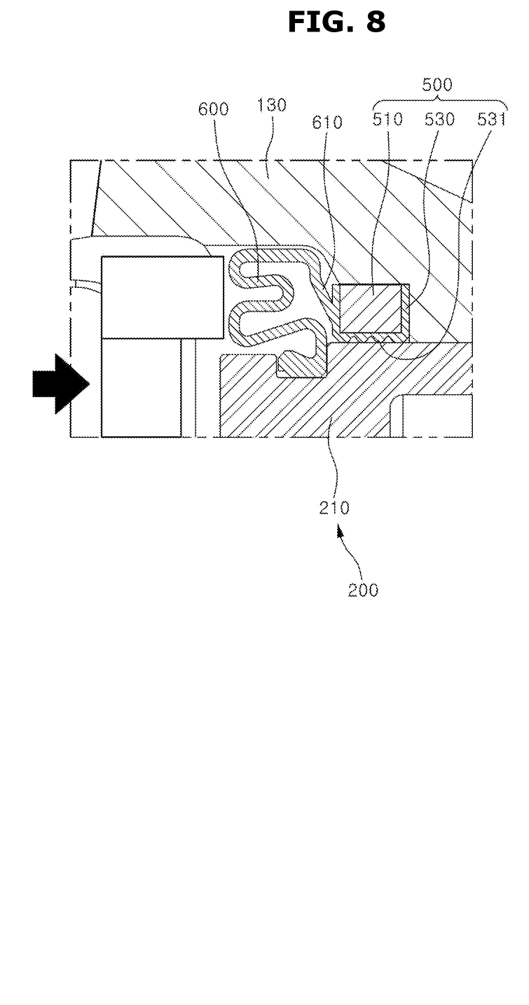

FIG. 1 is a perspective view of a brake apparatus for a vehicle according to a first embodiment of the present disclosure, when viewed from one direction. FIG. 2 is a perspective view of FIG. 1, when viewed from another direction. FIG. 3 is a cross-sectional view schematically showing the brake apparatus for a vehicle according to the first embodiment of the present disclosure. FIG. 4 is a partially enlarged view of FIG. 3. FIG. 5 is an exploded perspective view of the brake apparatus for a vehicle according to the first embodiment of the present disclosure, when viewed from one direction. FIG. 6 is an exploded perspective view of FIG. 5 when viewed from another direction. FIGS. 7 and 8 are partially enlarged cross-sectional views schematically showing an assembly process of the brake apparatus for a vehicle according to the first embodiment of the present disclosure.

Referring to FIGS. 1 to 8, the brake apparatus for a vehicle according to the first embodiment of the present disclosure includes a caliper body 100, a piston 200, a nut screw 300, a bolt screw 400, and a retainer 500.

The caliper body 100 may form an overall exterior appearance of the brake apparatus for a vehicle according to the present embodiment, and may support as a whole the piston 200, the nut screw 300, the bolt screw 400, and the retainer 500.

The caliper body 100 may include a bridge 110, a finger 120, and a cylinder 130.

The bridge 110 may form a central exterior appearance of the caliper body 100, and may support the finger 120 and the cylinder 130. The bridge 110 may be connected to a carrier 10, fixed to a knuckle (not illustrated) or the like, by means of a guide rod 11.

The bridge 110 may be connected to the carrier 10 to be capable of reciprocating along a first direction D1 or a second direction D2. The first direction D1 and the second direction D2 may be exemplified by directions, which are parallel to a central axis C1 of a brake disc 20, i.e., the X-axis in FIG. 3, and are opposite to each other.

A lower surface of the bridge 110 may be disposed to face a peripheral surface of the brake disc 20 by being spaced apart a set distance from the same. Both sides of the bridge 110 may extend along the first direction D1 and the second direction D2, respectively, with respect to the brake disc 20.

A pair of brake pads 30 may be disposed below the bridge 110. The pair of brake pads 30 may be spaced apart from each other along the central axis C1 of the brake disc 20. The pair of brake pads 30 may be disposed to face each other with the brake disc 20 interposed therebetween.

Any one brake pad 30 of the pair of brake pads 30 may be disposed to be spaced apart from the brake disc 20 along the first direction D1, and the other brake pad 30 may be disposed to be spaced apart from the brake disc 20 along the second direction D2.

The pair of brake pads 30 may be supported on the carrier 10 or the bridge 110 to be slidably movable in the first direction D1 and the second direction D2. A friction pad including a material having a high coefficient of friction, such as rubber, may be attached to one surface of the brake pad 30 facing the brake disc 20.

The finger 120 may extend downward from one side of the bridge 110. The finger 120 may be disposed to face any one brake pad 30 of the pair of brake pads 30.

The finger 120 may be disposed to face the brake pad 30, spaced apart from the brake disc 20 in the first direction D1, of the pair of brake pads 30.

In response to the bridge 110 moving along the second direction D2, the finger 120 may press the brake pad 30, spaced apart from the brake disc 20 in the first direction D1, toward the brake disc 20.

The cylinder 130 may extend downward from the other side of the bridge 110. The cylinder 130 may be formed in a cylindrical shape with a hollow interior and one side open. The open side of the cylinder 130 may be disposed to face the other brake pad 30 of the pair of brake pads 30.

The open side of the cylinder 130 may be disposed to face the brake pad 30, spaced apart from the brake disc 20 in the second direction D2, of the pair of brake pads 30. The open side of the cylinder 130 may be spaced apart a set distance from the brake pad 30 spaced apart from the brake disc 20 in the second direction D2.

A central axis C2 of the cylinder 130 may be disposed parallel to the central axis C1 of the brake disc 20. The central axis C2 of the cylinder 130 may be spaced apart from the central axis C1 of the brake disc 20 along a third direction D3.

The third direction D3 may be exemplified by a direction, which is perpendicular to the first direction D1 and the second direction D2 and oriented from the central axis C1 of the brake disc 20 toward the central axis C2 of the cylinder 130.

The third direction D3 may be a direction perpendicular to a ground surface, i.e., a direction rising along the Z-axis direction in FIG. 3, when the lower surface of the bridge 110 is disposed parallel to the ground surface.

The piston 200 may be installed in the cylinder 130 to be movable in the first direction D1 or the second direction D2. The piston 200 may be disposed inside the cylinder 130. The piston 200 may be formed in a hollow shape with one side open. A closed side of the piston 200 may be disposed to be oriented toward the brake pad 30, which is disposed to face the cylinder 130.

The open side of the piston 200 may be disposed to be oriented toward an internal space of the cylinder 130. An outer surface of the piston 200 may be supported on an inner surface of the cylinder 130 to be slidably movable. Alternatively, the outer surface of the piston 200 may be spaced apart a set distance from the inner surface of the cylinder 130 to form a clearance.

As the piston 200 moves in the first direction D1, the piston 200 may protrude toward the outside of the cylinder 130, and may move the brake pad 30 disposed to face the cylinder 130 toward the brake disc 20. In response to the moved brake pad 30 pressing the brake disc 20, braking force of the brake apparatus for a vehicle is generated.

The bridge 110 may move in the second direction D2 by reaction force generated between the piston 200 and the brake pad 30. As the piston 200 moves in the second direction D2, the piston 200 may release the pressure applied to the brake pad 30, and may be separated from the brake pad 30.

The piston 200 may interfere with the bolt screw 400 to restrict rotation of the bolt screw 400. The bolt screw 400 may interfere with the piston 200 to restrict axial rotation of the bolt screw 400. The piston 200 may include a piston body 210, a first interference portion 220, and a second interference portion 230.

The piston body 210 may form an overall exterior appearance of the piston 200, and may be formed in a cylindrical shape with a hollow interior. The bolt screw 400 may be inserted into the piston body 210. To be more specific, a bolt head 420 may be inserted into the piston body 210.

The first interference portion 220 may be provided on an inner peripheral surface of the piston body 210. The first interference portion 220 may interfere with the bolt screw 400. To be more specific, the first interference portion 220 may interfere with the bolt head 420.

The first interference portion 220 may be formed to protrude from the inner peripheral surface of the piston body 210. The first interference portion 220 may extend, with a set thickness, from the inner peripheral surface of the piston body 210 toward a central portion of the piston body 210. A portion of the first interference portion 220 oriented toward the piston body 210 may be formed as a flat surface.

In another embodiment, if a third interference portion 430 has a convex shape, the first interference portion 220 may also be formed to be recessed in the inner peripheral surface of the piston body 210.

A plurality of the first interference portions 220 may be provided. The plurality of the first interference portions 220 may be disposed to be spaced apart from each other along a circumferential direction of the piston body 210. For example, a pair of the first interference portions 220 may be disposed to face each other.

The pair of the first interference portions 220 may be disposed on both sides of the piston body 210. To be more specific, the pair of the first interference portions 220 may be disposed at the 3 o'clock and 9 o'clock positions of the piston body 210, respectively, when the piston body 210 is viewed from the front.

The second interference portion 230 may be provided on an outer peripheral surface of the piston body 210. The second interference portion 230 may interfere with the retainer 500. To be more specific, the second interference portion 230 may interfere with a fourth interference portion 520.

The second interference portion 230 may be formed to be recessed in the outer peripheral surface of the piston body 210. The second interference portion 230 may be formed to have a recess shape.

In another embodiment, if the fourth interference portion has a concave shape, the second interference portion 230 may also be formed to protrude from the outer peripheral surface of the piston body 210.

The second interference portion 230 may guide a linear movement of the piston 200 moving in the first direction D1 or the second direction D2. The second interference portion 230 may extend along a direction of a central axis C3 of the piston 200.

The second interference portion 230 may extend along a lengthwise direction of the piston body 210, i.e., along a direction parallel to the first direction D1 and/or the second direction D2. The second interference portion 230 may be formed in a long-hole shape having a set length.

A piston boot 600 may be installed inside the cylinder 130 to prevent an entry of external foreign substances and seal the interior of the cylinder 130. The piston boot 600 may be installed between the cylinder 130 and the piston 200. The piston boot 600 may be coupled to the piston body 210, and may be press-fit to the cylinder 130.

The piston boot 600 may be formed to surround the piston body 210. The piston boot 600 may be disposed along the first direction D1 from the second interference portion 230 and the retainer 500.

The piston boot 600 may include an elastically deformable material. For example, the piston boot 600 may be made of a rubber material. The piston boot 600 may be formed to have a corrugated configuration.

The nut screw 300 may be rotatably disposed in the cylinder 130, and may be connected to the bolt screw 400. A bearing 700 that rotatably supports the nut screw 300 may be installed inside the cylinder 130. The bearing 700 may be exemplified by a ball bearing provided between the cylinder 130 and the nut screw 300.

The nut screw 300 may be formed in a hollow shape with a hollow interior and both ends open. The nut screw 300 may be disposed inside the cylinder 130, and a central axis of the nut screw 300 may be located coaxially with the central axis C2 of the cylinder 130.

One side (the left side in FIG. 3) of the nut screw 300 may be disposed to face an inner surface of the piston 200 by being spaced apart a set distance from the same. The other side (the right side in FIG. 3) of the nut screw 300 may protrude to the outside of the cylinder 130 by penetrating a closed side of the cylinder 130.

The other side of the nut screw 300 may be connected to a power transmission means (not illustrated) that receives rotational force from an actuator (not illustrated). The actuator may be exemplified by various types of electric motors capable of generating rotational force by receiving power from a vehicle battery (not illustrated) or the like.

The power transmission means may transmit the rotational force of the actuator to the nut screw 300. The power transmission means may include a plurality of gears sequentially engaged and coupled between the actuator and the nut screw 300. However, the power transmission means is not limited to such a configuration, and the type of power transmission means, capable of receiving rotational force from the actuator to rotate the nut screw 300, may vary with a design change.

During operation of the actuator, the nut screw 300 may receive, through the power transmission means, the rotational force generated from the actuator, and may rotate clockwise or counterclockwise around the central axis of the nut screw 300.

The nut screw 300 may be disposed such that an inner surface of the nut screw 300 faces an outer surface of the bolt screw 400. A ball rail may be formed on an inner peripheral surface of the nut screw 300, wherein one side of the circumference of a ball member B in a sphere shape is seated on the ball rail. The ball rail may extend in a spiral shape along a lengthwise direction of the nut screw 300 to provide a circulation path for the ball member B.

In conjunction with the rotation of the nut screw 300, the bolt screw 400 may move in the first direction D1 or the second direction D2 inside the cylinder 130. The bolt screw 400 may be disposed inside the nut screw 300. The bolt screw 400 may be disposed to penetrate both ends of the nut screw 300.

As the bolt screw 400 moves in the first direction D1, the bolt screw 400 may press the piston 200 in the first direction D1; and as the bolt screw 400 moves in the second direction D2, the bolt screw 400 may release the pressure applied to the piston 200.

The bolt screw 400 may include a bolt body 410, the bolt head 420, and the third interference portion 430.

The bolt body 410 may be formed in a rod shape having roughly a circular cross-section. The bolt body 410 may be disposed inside the cylinder 130, and a central axis of the bolt body 410 may be located coaxially with the central axis C2 of the cylinder 130. The bolt body 410 may be coupled to the nut screw 300 by means of the ball member B.

A ball rail may be formed on an outer peripheral surface of the bolt body 410, wherein the other side of the circumference of the ball member B is seated on the ball rail. The ball rail may extend in a spiral shape along a lengthwise direction of the bolt body 410 to provide a circulation path for the ball member B. Accordingly, in response to rotation of the nut screw 300, the bolt body 410 may move in the first direction D1 or the second direction D2 by circulation of the ball member B along the ball rail.

The bolt head 420 may be disposed between the bolt body 410 and the piston 200. The bolt head 420 may be formed to have roughly a circular cross-section. The bolt head 420 may be inserted into the piston body 210. The bolt head 420 may be disposed to face an inner surface of the piston body 210 by being spaced apart a set distance from the same.

The bolt head 420 may press the piston body 210. The bolt head 420 may press the piston body 210 in the first direction D1 or release the pressure applied to the piston body 210 depending on a direction of movement of the bolt body 410.

The bolt head 420 may be provided on one side (the left side in FIG. 3) of the bolt body 410 disposed to face the piston 200.

A diameter of the bolt head 420 may be formed larger than a diameter of the bolt body 410. An outer diameter of the bolt head 420 may be formed larger than an inner diameter of the nut screw 300. Accordingly, the bolt head 420 may protrude from the nut screw 300.

As the bolt body 410 moves in the first direction D1, the bolt head 420 may come into contact with the inner surface of the piston body 210, and may press the piston body 210 in the first direction D1.

As the bolt body 410 moves in the second direction D2, the bolt head 420 may be separated from the inner surface of the piston body 210, and may release the pressure applied to the piston body 210.

The third interference portion 430 may be provided on an outer peripheral surface of the bolt head 420. The third interference portion 430 may come into contact with the first interference portion 220. The third interference portion 430 may interfere with the first interference portion 220.

The third interference portion 430 may be formed as a flat surface to correspond to the first interference portion 220. The third interference portion 430 may be formed as a flat surface by cutting off a portion of the outer peripheral surface of the bolt head 420.

The third interference portion 430 may come into surface contact with the first interference portion 220. In another embodiment, if the first interference portion 220 has a concave shape, the third interference portion 430 may also be formed to protrude from the outer peripheral surface of the bolt head 420.

A plurality of the third interference portions 430 may be provided. The plurality of the third interference portions 430 may be disposed to be spaced apart from each other along a circumferential direction of the bolt head 420. For example, a pair of the third interference portions 430 may be disposed to face each other.

The pair of the third interference portions 430 may be disposed on both sides of the bolt head 420. To be more specific, the pair of the third interference portions 430 may be disposed at the 3 o'clock and 9 o'clock positions of the bolt head 420, respectively, when the bolt head 420 is viewed from the front. That is, the third interference portion 430 may be disposed at a location corresponding to the first interference portion 220. Since the third interference portion 430 interferes with the first interference portion 220, axial rotation of the bolt screw 400 may be restricted.

The bolt head 420 according to the present embodiment may further be provided with a pressing portion 421 coming into contact with the inner surface of the piston body 210.

The pressing portion 421 may be formed to protrude from the bolt head 420. The pressing portion 421 may protrude from the outer peripheral surface of the bolt head 420, and may be formed along the circumferential direction of the bolt head 420.

The pressing portion 421 may be provided on one side (the left side in FIG. 4) of the bolt head 420 oriented toward a direction in which the piston 200 is located.

The retainer 500 may be secured to the cylinder 130. The retainer 500 may interfere with the piston 200 to restrict rotation of the piston 200. The piston 200 may interfere with the retainer 500 to restrict axial rotation of the piston 200. The retainer 500 may include a metal material.

The retainer 500 may include a retainer body 510, the fourth interference portion 520, and a damper 530.

The retainer body 510 may be formed in a ring shape. The retainer body 510 may be disposed between the cylinder 130 and the piston 200. The retainer body 510 may be interposed between the inner surface of the cylinder 130 and the outer peripheral surface of the piston body 210.

The retainer body 510 may be secured to the cylinder 130 in a way that the retainer body 510 is secured to the inner surface of the cylinder 130 by a coupling method such as bolting or pin coupling, and may be secured to the cylinder 130 in a way that the retainer body 510 is secured inside the cylinder 130 by an assembly method such as press-fitting or serration press-fitting.

The fourth interference portion 520 may be provided on an inner peripheral surface of the retainer body 510. The fourth interference portion 520 may come into contact with the second interference portion 230. The fourth interference portion 520 may interfere with the second interference portion 230.

The fourth interference portion 520 may be formed to protrude from the inner peripheral surface of the retainer body 510. The fourth interference portion 520 may be formed to have roughly a protrusion shape. The fourth interference portion 520 may extend, with a set thickness, from the inner peripheral surface of the retainer body 510 toward a central portion of the retainer body 510.

The fourth interference portion 520 may be accommodated in the second interference portion 230 to be seated inside the second interference portion 230.

In another embodiment, if the second interference portion 230 has a convex shape, the fourth interference portion 520 may also be formed to be recessed in the inner peripheral surface of the retainer body 510.

A plurality of the fourth interference portions 520 may be provided. The plurality of the fourth interference portions 520 may be disposed to be spaced apart from each other along a circumferential direction of the retainer body 510. For example, a pair of the fourth interference portions 520 may be disposed to face each other.

The pair of the fourth interference portions 520 may be disposed on both sides of the retainer body 510. To be more specific, the pair of the fourth interference portions 520 may be disposed at the 3 o'clock and 9 o'clock positions of the retainer body 510, when the retainer body 510 is viewed from the front. That is, the fourth interference portion 520 may be disposed at a location corresponding to the second interference portion 230.

Since the retainer body 510 is secured to the cylinder 130, and the fourth interference portion 520 interferes with the second interference portion 230, axial rotation of the piston 200 may be restricted. Since the axial rotation of the piston 200 is restricted, axial rotation of the bolt screw 400 may be restricted.

Since the fourth interference portion 520 is seated inside the second interference portion 230, the linear movement of the piston 200 moving in the first direction D1 or the second direction D2 may be guided.

The damper 530 may be coupled to the retainer body 510. The damper 530 may be configured to surround the retainer body 510. The damper 530 may come into contact with the piston 200.

The damper 530 may be disposed between the retainer body 510 and the piston 200. The damper 530 may be disposed between the inner peripheral surface of the retainer body 510 and the outer peripheral surface of the piston body 210. The damper 530 may come into close contact with the piston body 210.

The damper 530 may include an elastically deformable material. For example, the damper 530 may be made of a rubber material. The damper 530 may be integrally provided with the retainer body 510. The damper 530 may be insert-molded into the retainer 500. The fourth interference portion 520 may protrude from the damper 530.

The damper 530 may elastically support the piston 200. To be more specific, the damper 530 may elastically support the piston body 210.

The piston boot 600 may be integrally formed with the damper 530. In the present embodiment, the piston boot 600 is integrally connected to the damper 530 through a connecting boot portion 610. Accordingly, the piston boot 600 and the retainer 500 may be unified into a single component, thereby enabling cost reduction and simplification of an assembly process.

The damper 530 may further be provided with a projection portion 531. The projection portion 531 may be formed to protrude from an outer surface of the damper 530 coming into contact with the piston body 210. The projection portion 531 may be seated on the piston 200. The projection portion 531 may be seated on the outer peripheral surface of the piston body 210.

A plurality of the projection portions 531 may be disposed, along a direction of a central axis C4 of the retainer 500, to be spaced apart from each other. Here, the central axis C4 of the retainer 500 may be located coaxially with the central axis C3 of the piston 200.

Elastic force of the projection portion 531 is applied to the piston 200 toward a central portion of the piston 200, such that the piston 200 may maintain centering. This may enable smooth linear motion of the piston 200 moving in the first direction D1 or the second direction D2, thereby ensuring the straight-line stability of the piston 200.

The projection portion 531 may absorb vibrations generated when the piston 200 moves in the first direction D1 or the second direction D2, thereby reducing rattle noise.

A groove formed between the plurality of the projection portions 531, which are disposed, along the direction of the central axis C4 of the retainer 500, to be spaced apart from each other, may act as a grease (lubricant) pocket to form a stable lubrication film when the piston 200 moves in the first direction D1 or the second direction D2, thereby minimizing sliding resistance of the piston 200.

The following is the description of an assembly process of the brake apparatus for a vehicle with the configuration described above according to embodiments of the present disclosure.

Referring to FIG. 7, the retainer 500 is press-fit to the cylinder 130. A load is applied to the retainer body 510 in the second direction D2 to press-fit the retainer body 510 into the cylinder 130. The retainer body 510 may be secured to the cylinder 130 in a way that the retainer body 510 is secured inside the cylinder 130 by an assembly method such as press-fitting or serration press-fitting, and may be secured to the cylinder 130 in a way that the retainer body 510 is secured to the inner surface of the cylinder 130 by a coupling method such as bolting or pin coupling.

Referring to FIG. 8, the piston 200 is inserted into the cylinder 130. The piston boot 600 is press-fit to the cylinder 130 by applying a load, which is smaller than the load applied to the retainer body 510, to the piston boot 600, which is coupled to the piston body 210, in the second direction D2.

With the brake apparatus for a vehicle according to embodiments of the present disclosure, the second interference portion 230 formed on the piston 200 interferes with the fourth interference portion 520 formed on the retainer 500, thereby preventing rotation of the piston 200; and the third interference portion 430 formed on the bolt head 420 interferes with the first interference portion 220 formed on the piston 200, thereby preventing rotation of the bolt screw 400.

With the brake apparatus for a vehicle according to embodiments of the present disclosure, elastic force of the projection portion 531 formed on the damper 530 is applied to the piston 200 toward the central portion of the piston 200, thereby maintaining centering of the piston 200.

With the brake apparatus for a vehicle according to embodiments of the present disclosure, the groove formed between the plurality of the projection portions 531 may act as a grease (lubricant) pocket to form a stable lubrication film when the piston 200 moves, thereby minimizing sliding resistance of the piston 200.

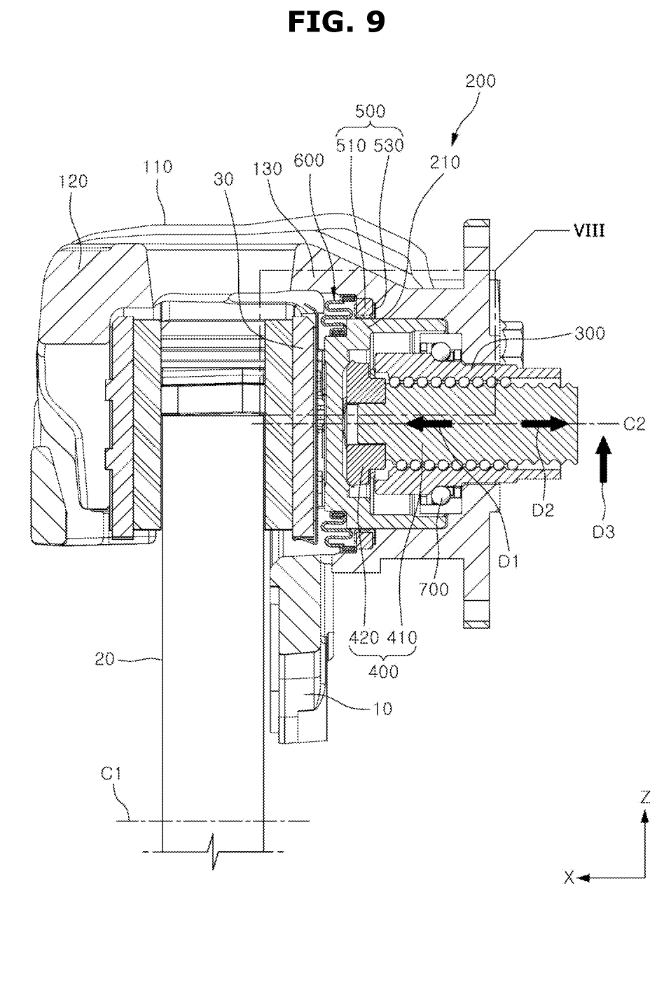

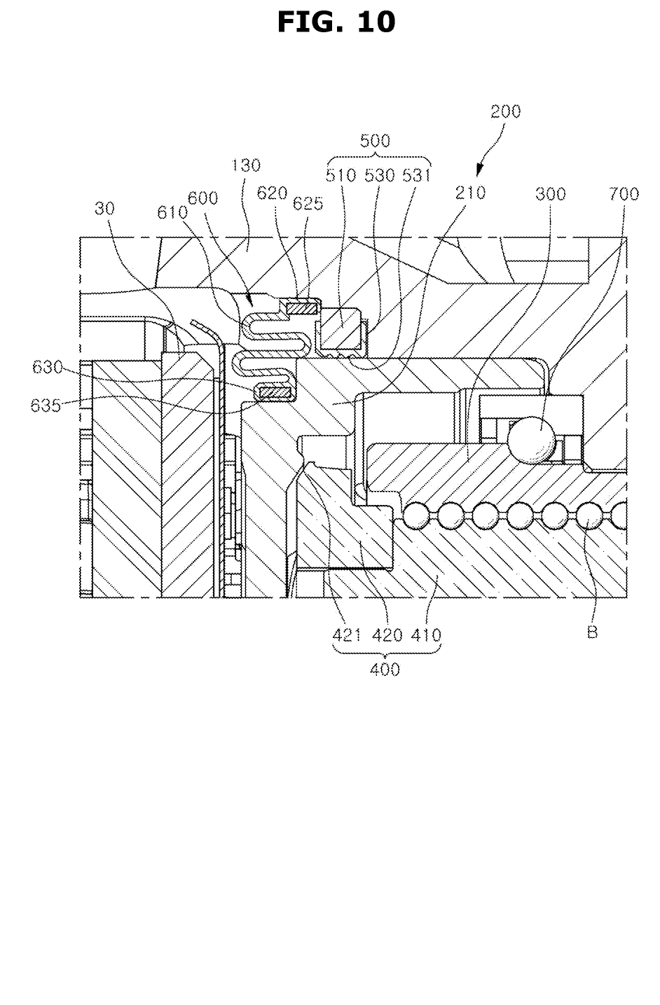

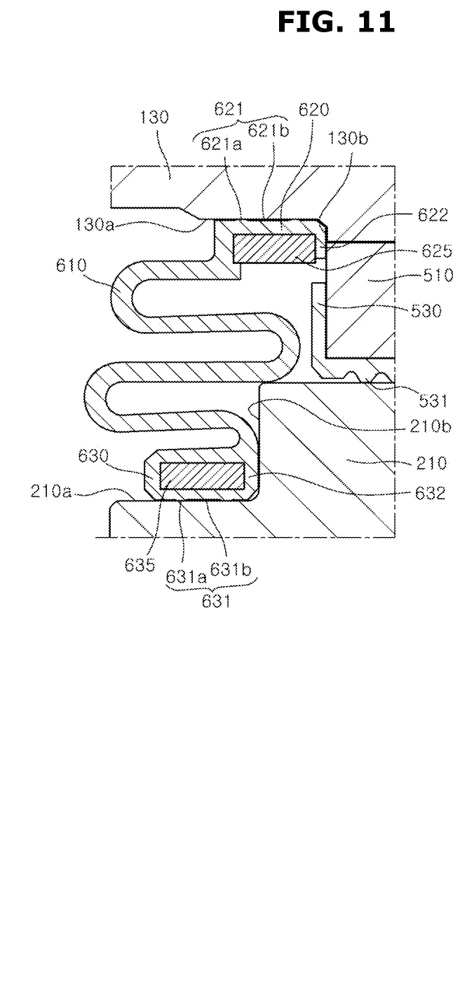

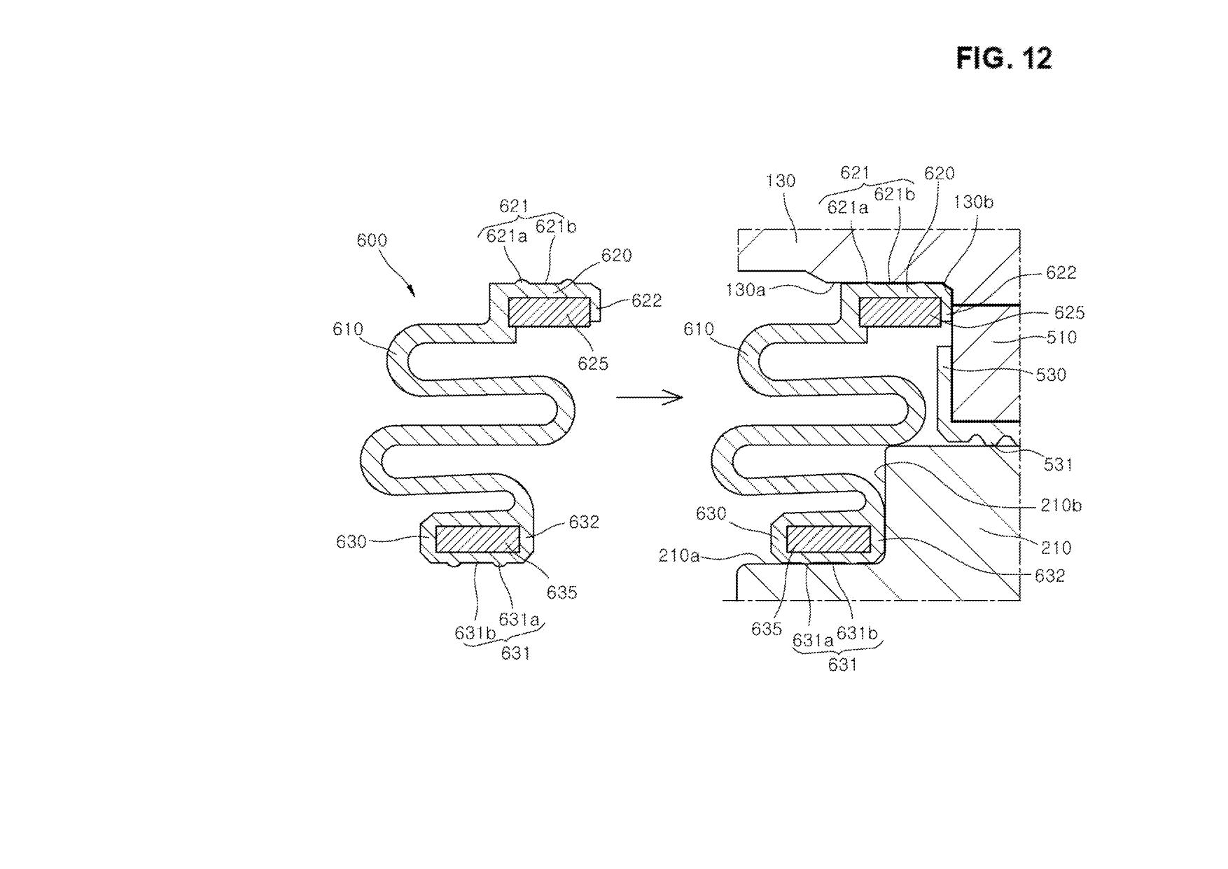

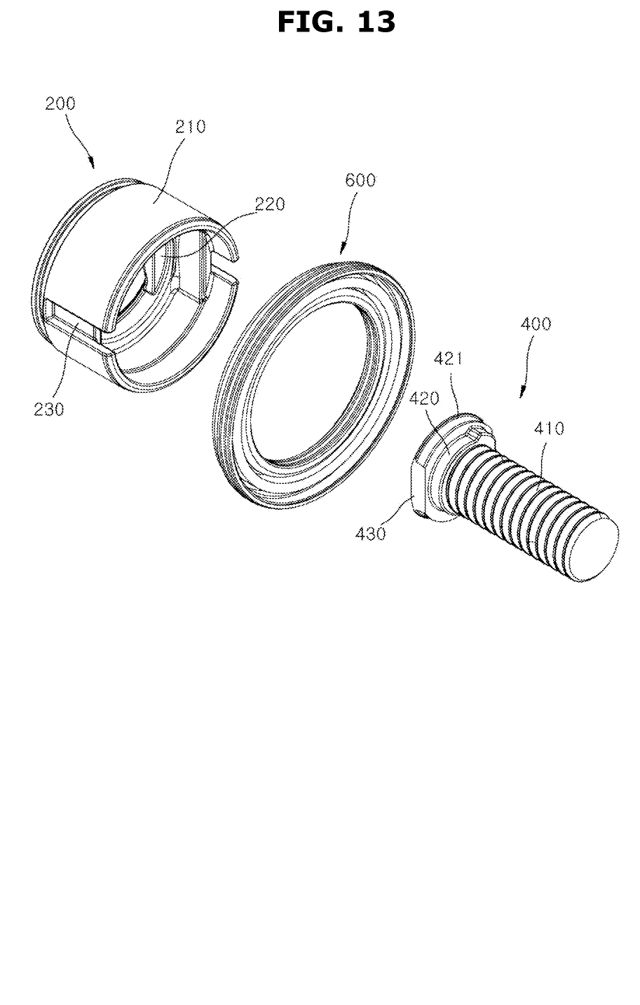

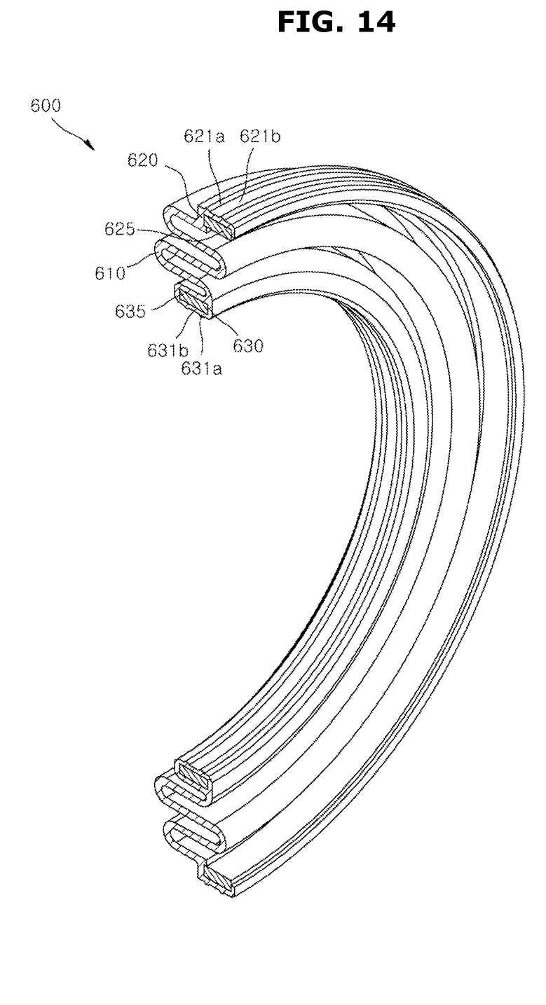

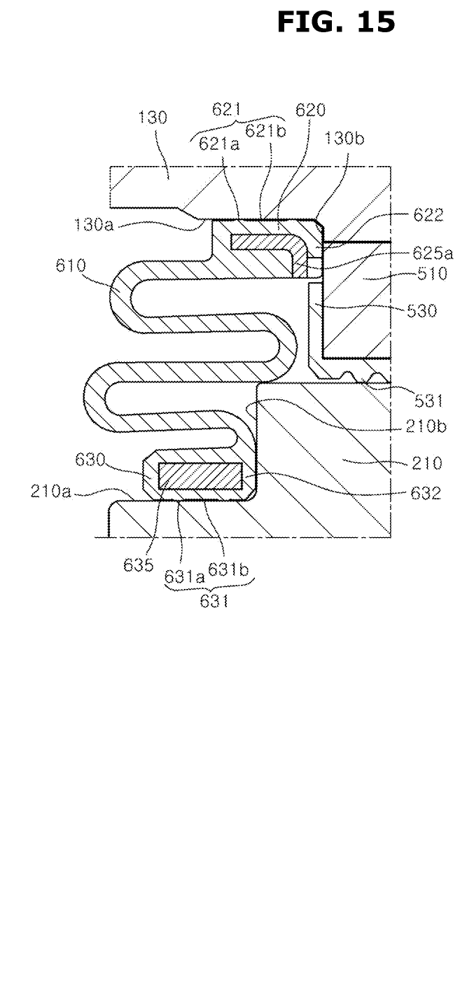

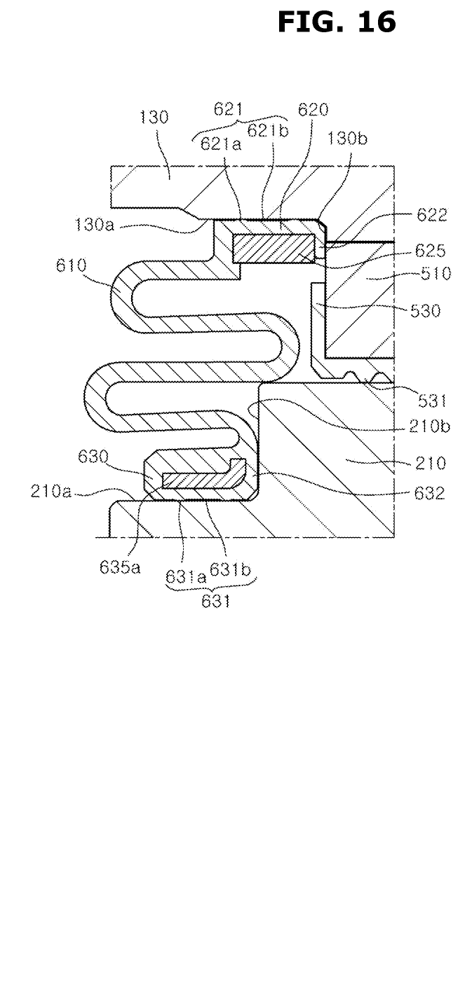

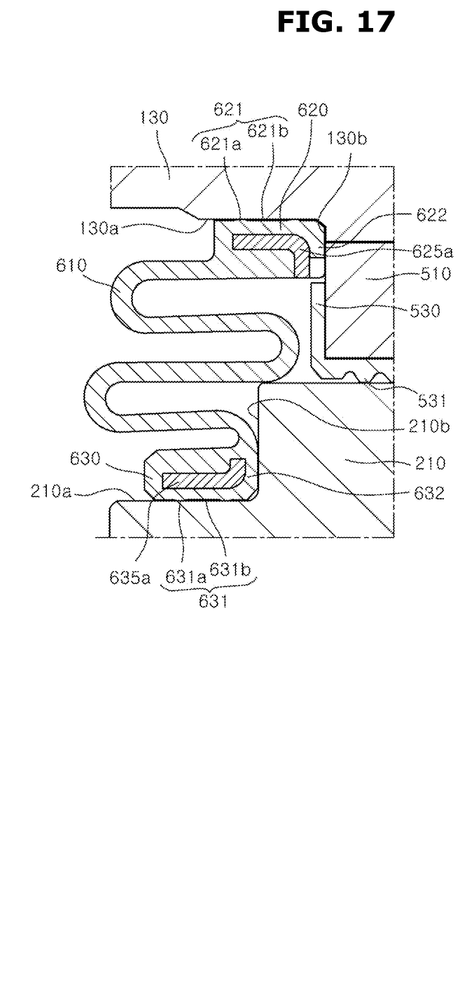

FIG. 9 is a cross-sectional view schematically showing a brake apparatus for a vehicle according to a second embodiment of the present disclosure. FIG. 10 is an enlarged view of section IV in FIG. 9. FIG. 11 is a cross-sectional view showing a piston boot according to the second embodiment of the present disclosure. FIG. 12 is a cross-sectional view showing a mounting process of the piston boot according to the second embodiment of the present disclosure. FIG. 13 is an exploded perspective view showing the brake apparatus for a vehicle according to the second embodiment of the present disclosure. FIG. 14 is a cross-sectional perspective view showing the piston boot according to the second embodiment of the present disclosure. FIG. 15 is a cross-sectional view showing a first modification of the piston boot according to the second embodiment of the present disclosure. FIG. 16 is a cross-sectional view showing a second modification of the piston boot according to the second embodiment of the present disclosure. FIG. 17 is a cross-sectional view showing a third modification of the piston boot according to the second embodiment of the present disclosure.

Referring to FIGS. 1 and 2 and FIGS. 9 to 17, the brake apparatus for a vehicle according to the second embodiment of the present disclosure includes the caliper body 100, the piston 200, the nut screw 300, the bolt screw 400, and the piston boot 600. The brake apparatus for a vehicle according to the second embodiment of the present disclosure may be a dry-type electro mechanical brake (EMB) that does not use hydraulic pressure. In the first and second embodiments of the present disclosure, components designated by the same reference numerals have identical structure and functions; therefore, in the following description of the second embodiment, redundant descriptions of aspects common to those of the first embodiment will be omitted.

The piston boot 600 is disposed between the cylinder 130 and the piston 200 to prevent an entry of foreign substances or liquid into the interior of the cylinder 130. The piston boot 600 may be fit to both the cylinder 130 and the piston 200, thereby sealing the interior of the cylinder 130. That is, one side of the piston boot 600 may be fit to an inner wall 130a of the cylinder 130, and the other side of the piston boot 600 may be fit to an outer wall 210a of the piston 200.

As used herein, the term “liquid” is not limited to any particular substance, but encompasses all forms of liquid that may enter from the outside under the vehicle's operating environment. For example, the term may include wash water used during vehicle cleaning, rainwater entering during rainfall, water splashed from a puddle on a road, and meltwater generated during snow removal. In addition, the term is not limited to the above examples, and may also include a variety of liquid such as oil, solvent, and condensed moisture.

One side of the piston boot 600 may be interference-fit, more specifically press-fit, to the inner wall 130a of the cylinder 130; and the other side of the piston boot 600 may be interference-fit, more specifically press-fit, to the outer wall 210a of the piston body 210. Since the piston boot 600 is press-fit to both the cylinder 130 and the piston body 210, sealing strength between the piston boot 600 and the cylinder 130, and between the piston boot 600 and the piston body 210, is increased.

The piston boot 600 may be formed to surround the piston body 210. The piston boot 600 may be formed in a ring shape with a hollow central portion. The piston boot 600 may have a closed-ring shape with a continuous circumference, or in another example, may have an open-ring shape with an interrupted circumference. If the piston boot 600 has an open-ring shape, two ends of the piston boot 600 may be spaced apart from each other, may be come into contact with each other, or may be joined with a partial overlap. In addition, if necessary, the two ends may be coupled to each other by a fastening member, adhesion, welding, or elastic deformation. The piston boot 600 may be disposed along the first direction D1 from the second interference portion 230 and the retainer 500.

The piston boot 600 may include an outer boot portion 620, an inner boot portion 630, and the connecting boot portion 610. The piston boot 600 may be made of an elastically deformable material.

The outer boot portion 620 may be fit to the inner wall 130a of the cylinder 130, and may accommodate a first metal insert 625 or 625a. The outer boot portion 620 may be made of a rubber material, and the first metal insert 625 or 625a may be made of a metal material. For example, the first metal insert 625 or 625a may include a steel material.

The first metal insert 625 or 625a may be inserted into and integrated with the outer boot portion 620 by insert injection molding. Accordingly, in response to the outer boot portion 620 being press-fit to the inner wall 130a of the cylinder 130, the first metal insert 625 or 625a may support the outer boot portion 620, thereby enhancing coupling strength between the outer boot portion 620 and the cylinder 130.

The outer boot portion 620 may be disposed such that an outer surface 621 comes into contact with the inner wall 130a of the cylinder 130. Accordingly, the outer boot portion 620 may seal between the piston 200 and the cylinder 130 in a radial direction (the vertical direction in FIG. 10). The outer surface 621 of the outer boot portion 620 may come into surface contact with the inner wall 130a of the cylinder 130.

The first metal insert 625 or 625a does not come into contact with the inner wall 130a of the cylinder 130. That is, the first metal insert 625 or 625a may be partially or entirely surrounded by the outer surface 621 of the outer boot portion 620. Accordingly, the first metal insert 625 or 625a supports the outer boot portion 620 and does not come into direct contact with the cylinder 130, which is made of a metal material, thereby reducing noise generation and enhancing sealing strength between the outer boot portion 620 and the cylinder 130.

The outer boot portion 620 may be disposed such that a side surface 622 comes into contact with the retainer 500, for example, the retainer body 510. Accordingly, the outer boot portion 620 may seal between the cylinder 130 and the retainer 500 in an axial direction (the lateral direction in FIG. 10). To be more specific, the side surface 622 of the outer boot portion 620 may be disposed to overlap between the cylinder 130 and an outer surface of the retainer body 510 that the side surface 622 of the outer boot portion 620 comes into contact with. Accordingly, the outer boot portion 620 may seal between the cylinder 130 and the retainer body 510. As described above, the outer boot portion 620 seals between two members, that is between the cylinder 130 and the piston 200, and between the cylinder 130 and the retainer 500, thereby blocking, from the outset, both foreign substances and liquid from entering the interior of the cylinder 130 from the outside.

The side surface 622 of the outer boot portion 620 may come into surface contact with the retainer body 510. Accordingly, since the outer surface 621 is press-fit to the inner wall 130a of the cylinder 130, the outer boot portion 620 may directly support the retainer body 510, thereby providing a sealing effect and preventing the retainer body 510 from being dislodged from its original position.

The outer boot portion 620 may be disposed such that the side surface 622 comes into contact with a side wall 130b of the cylinder 130. The side wall 130b is a portion formed to be stepped relative to the inner wall 130a. Since the outer boot portion 620 comes into contact with the inner wall 130a and the side wall 130b of the cylinder 130, the outer boot portion 620 may come into close contact with the cylinder 130 not only in the radial direction but also in the axial direction.

The first metal insert 625 or 625a may not come into contact with the retainer body 510. That is, the first metal insert 625 or 625a may be partially or entirely surrounded by the side surface 622 of the outer boot portion 620. Accordingly, the first metal insert 625 or 625a supports the side surface 622 of the outer boot portion 620 and does not come into direct contact with the retainer body 510, which is made of metal, thereby suppressing noise generation and enhancing sealing strength between the outer boot portion 620 and the retainer body 510.

The outer boot portion 620 may be provided with one or more outer projections 621a that protrude outward from a portion opposing the inner wall 130a of the cylinder 130, for example, from the outer surface 621.

In response to the outer boot portion 620 being press-fit to the inner wall 130a of the cylinder 130, the outer projection 621a is elastically deformed, thereby enhancing sealing strength between the outer boot portion 620 and the inner wall 130a of the cylinder 130. In response to the outer projection 621a being elastically deformed and coming into close contact with the inner wall 130a of the cylinder 130, a remaining portion 621b of the outer surface 621 may also come into close contact with the inner wall 130a of the cylinder 130, thereby enhancing sealing strength.

The inner boot portion 630 may be fit to the outer wall 210a of the piston body 210, and may accommodate a second metal insert 635 or 635a. The inner boot portion 630 may be made of a rubber material, and the second metal insert 635 or 635a may be made of a metal material. For example, the second metal insert 635 or 635a may include a steel material.

The second metal insert 635 or 635a may be inserted into and integrated with the inner boot portion 630 by insert injection molding. Accordingly, in response to the inner boot portion 630 being press-fit to the outer wall 210a of the piston body 210, the second metal insert 635 or 635a may support the inner boot portion 630, thereby enhancing coupling strength between the inner boot portion 630 and the piston body 210.

The inner boot portion 630 may be disposed such that an inner surface 631 comes into contact with the outer wall 210a of the piston body 210. Accordingly, the inner boot portion 630 may seal between the piston 200 and the cylinder 130 in the radial direction (the vertical direction in FIG. 10). The inner surface 631 of the inner boot portion 630 may come into surface contact with the outer wall 210a of the piston body 210.

The second metal insert 635 or 635a does not come into contact with the outer wall 210a of the piston body 210. That is, the second metal insert 635 or 635a may be partially or entirely surrounded by the inner surface 631 of the inner boot portion 630. Accordingly, the second metal insert 635 or 635a supports the inner boot portion 630 and does not come into direct contact with the piston body 210, which is made of a metal material, thereby reducing noise generation and enhancing sealing strength between the inner boot portion 630 and the piston 200.

The inner boot portion 630 may be disposed such that a side surface 632 comes into contact with a side wall 210b of the piston body 210. The side wall 210b is a portion formed to be stepped relative to the outer wall 210a. Since the inner boot portion 630 comes into contact with the outer wall 210a and the side wall 210b of the piston body 210, the inner boot portion 630 may come into close contact with the piston body 210 not only in the radial direction but also in the axial direction. As descried above, the inner boot portion 630 comes into close contact with the piston body 210 at two locations, thereby blocking, from the outset, both foreign substances and liquid from entering from the outside.

The second metal insert 635 or 635a may not come into contact with the side wall 210b of the piston body 210. That is, the second metal insert 635 or 635a may be partially or entirely surrounded by the side surface 632 of the inner boot portion 630. Accordingly, the second metal insert 635 or 635a supports the side surface 632 of the inner boot portion 630 and does not come into direct contact with the piston body 210, which is made of metal, thereby suppressing noise generation and enhancing sealing strength between the inner boot portion 630 and the side wall 210b of the piston body 210.

The inner boot portion 630 may be provided with one or more inner projections 631a that protrude inward (downward in FIG. 12) from a portion opposing the outer wall 210a of the piston body 210, for example, from the inner surface 631. Here, inward refers to a direction toward the central portion of the piston body 210.

In response to the inner boot portion 630 being press-fit to the outer wall 210a of the piston body 210, the inner projection 631a is elastically deformed, thereby enhancing sealing strength between the inner boot portion 630 and the outer wall 210a of the piston body 210. In response to the inner projection 631a being elastically deformed and coming into close contact with the outer wall 210a of the piston body 210, a remaining portion 631b of the inner surface 631 may also come into close contact with the outer wall 210a of the piston body 210, thereby enhancing sealing strength.

The connecting boot portion 610 connects the outer boot portion 620 and the inner boot portion 630. The outer boot portion 620, the inner boot portion 630, and the connecting boot portion 610 may be integrally formed.

The connecting boot portion 610 may have a cross-section formed in an accordion shape. In other words, the connecting boot portion 610 may be formed to have a corrugated configuration. In the connecting boot portion 610 folded into an accordion shape, spacing between each fold portion may be set to be uniform or substantially uniform. The connecting boot portion 610 is formed of a rubber material and, since its cross-section is formed in an accordion shape, the connecting boot portion 610 may be elastically deformed in response to an external force being applied.

The first metal insert 625 or 625a accommodated in the outer boot portion 620 and the second metal insert 635 or 635a accommodated in the inner boot portion 630 may be disposed to be biased toward one side of the connecting boot portion 610. For example, referring to FIG. 10, the first metal insert 625 or 625a and the second metal insert 635 or 635a may be disposed to be biased toward the retainer 500 relative to a central point of the connecting boot portion 610 in the axial direction (the lateral direction in FIG. 10). Accordingly, a leading end of the connecting boot portion 610 may be disposed further toward a leading end of the cylinder 130 than the first metal insert 625 or 625a and the second metal insert 635 or 635a, thereby blocking entry of foreign substances or liquid at an earlier position. Positions of the first metal insert 625 or 625a and the second metal insert 635 or 635a may correspond to press-fitting positions of the cylinder 130 and the piston 200 with the piston boot 600. The first metal insert 625 or 625a and the second metal insert 635 or 635a may be positioned in a direction in which a mold is removed during insert injection-molding of the piston boot 600.

The first metal insert 625 or 625a may be formed in a ring shape, and a part or the whole of the first metal insert 625 or 625a may be inserted into and accommodated in the outer boot portion 620. As shown in FIGS. 11 and 16, the first metal insert 625 may have a rectangular cross-section. Alternatively, as shown in FIGS. 15 and 17, the first metal insert 625a may have an L-shaped cross-section. For the first metal insert 625a having an L-shaped cross-section, one portion of the first metal insert 625a may be disposed parallel or substantially parallel to the inner wall 130a of the cylinder 130; and another portion of the first metal insert 625a may be bent inward from the one portion and disposed perpendicular or substantially perpendicular to the inner wall 130a of the cylinder 130. Accordingly, the one portion of the first metal insert 625a may be referred to as a horizontal bar or an inner-wall-opposing portion, and the another portion of the first metal insert 625a may be referred to as a vertical bar or a retainer-opposing portion. The retainer-opposing portion of the first metal insert 625a may be disposed parallel or substantially parallel to the side wall 130b of the cylinder 130 or the retainer body 510.

The inner-wall-opposing portion of the first metal insert 625a, which is a rigid member, may support the outer boot portion 620, thereby enhancing coupling strength between the outer boot portion 620 and the cylinder 130. The retainer-opposing portion of the first metal insert 625a, which is a rigid member, may support the retainer body 510 with the outer boot portion 620 interposed therebetween, thereby preventing the retainer body 510 from being dislodged from its original position.

The second metal insert 635 or 635a may be formed in a ring shape, and a part or the whole of the second metal insert 635 or 635a may be inserted into and accommodated in the inner boot portion 630. As shown in FIGS. 11 and 15, the second metal insert 635 may have a rectangular cross-section. Alternatively, as shown in FIGS. 16 and 17, the second metal insert 635a may have an L-shaped cross-section. For the second metal insert 635a having an L-shaped cross-section, one portion of the second metal insert 635a may be disposed parallel or substantially parallel to the outer wall 210a of the piston body 210; and another portion of the second metal insert 635a may be bent outward from the one portion and disposed perpendicular or substantially perpendicular to the outer wall 210a of the piston body 210. Accordingly, the one portion of the second metal insert 635a may be referred to as a horizontal bar or an outer-wall-opposing portion, and the another portion of the second metal insert 635a may be referred to as a vertical bar or a side-wall-opposing portion. The side-wall-opposing portion of the second metal insert 635a may be disposed parallel or substantially parallel to the side wall 210b of the piston body 210.

The outer-wall-opposing portion of the second metal insert 635a may support the inner boot portion 630, thereby enhancing coupling strength between the inner boot portion 630 and the outer wall 210a of the piston body 210. The side-wall-opposing portion of the second metal insert 635a may support the inner boot portion 630, thereby enhancing coupling strength between the inner boot portion 630 and the side wall 210b of the piston body 210.

The piston boot 600 may be assembled by first press-fitting the inner boot portion 630 to the piston 200, and then press-fitting the outer boot portion 620 to the cylinder 130 when the piston 200 is assembled to the caliper body 100. Accordingly, the assembly of the piston boot 600 may be completed during assembly of the piston 200, thereby simplifying an assembly process and reducing an assembly defect rate. In addition, the first metal insert 625 or 625a and the second metal insert 635 or 635a are insert-molded into the outer boot portion 620 and the inner boot portion 630, respectively, to be integrally formed, thereby preventing the outer boot portion 620 and the inner boot portion 630 from being pinched during assembly, thereby improving assemblability.

The nut screw 300 may be rotatably disposed in the cylinder 130, and may be connected to the bolt screw 400. The bearing 700 that rotatably supports the nut screw 300 may be installed inside the cylinder 130. The bearing 700 may be exemplified by a ball bearing provided between the cylinder 130 and the nut screw 300.

The nut screw 300 may be formed in a hollow shape with a hollow interior and both ends open. The nut screw 300 may be disposed inside the cylinder 130, and a central axis of the nut screw 300 may be located coaxially with the central axis C2 of the cylinder 130.

One side (the left side in FIG. 9) of the nut screw 300 may be disposed to face the inner surface of the piston 200 by being spaced apart a set distance from the same. The other side (the right side in FIG. 9) of the nut screw 300 may protrude to the outside of the cylinder 130 by penetrating the cylinder 130.

The other side of the nut screw 300 may be connected to a power transmission means (not illustrated) that receives rotational force from an actuator (not illustrated). The actuator may be exemplified by various types of electric motors capable of generating rotational force by receiving power from a vehicle battery (not illustrated) or the like.

The power transmission means may transmit the rotational force of the actuator to the nut screw 300. The power transmission means may include a plurality of gears sequentially engaged and coupled between the actuator and the nut screw 300. However, the power transmission means is not limited to such a configuration, and the type of power transmission means, capable of receiving rotational force from the actuator to rotate the nut screw 300, may vary with a design change.

During operation of the actuator, the nut screw 300 may receive, through the power transmission means, the rotational force generated from the actuator, and may rotate clockwise or counterclockwise around the central axis of the nut screw 300.

The nut screw 300 may be disposed such that the inner surface of the nut screw 300 faces the outer surface of the bolt screw 400. A ball rail may be formed on the inner peripheral surface of the nut screw 300, wherein one side of the circumference of the ball member B in a sphere shape is seated on the ball rail. The ball rail may extend in a spiral shape along the lengthwise direction of the nut screw 300 to provide a circulation path for the ball member B.

In conjunction with the rotation of the nut screw 300, the bolt screw 400 may reciprocate in the first direction D1 or the second direction D2 inside the cylinder 130. The bolt screw 400 may be disposed inside the nut screw 300. The bolt screw 400 may be disposed to penetrate both ends of the nut screw 300.

As the bolt screw 400 moves in the first direction D1, the bolt screw 400 may press the piston 200 in the first direction D1; and as the bolt screw 400 moves in the second direction D2, the bolt screw 400 may release the pressure applied to the piston 200.

The bolt screw 400 may include the bolt body 410, the bolt head 420, and the third interference portion 430.

The bolt body 410 may be formed in a rod shape having roughly a circular cross-section. The bolt body 410 may be disposed inside the cylinder 130, and the central axis of the bolt body 410 may be located coaxially with the central axis C2 of the cylinder 130. The bolt body 410 may be coupled to the nut screw 300 by means of the ball member B.

A ball rail may be formed on the outer peripheral surface of the bolt body 410, wherein the other side of the circumference of the ball member B is seated on the ball rail. The ball rail may extend in a spiral shape along the lengthwise direction of the bolt body 410 to provide a circulation path for the ball member B. Accordingly, in response to rotation of the nut screw 300, the bolt body 410 may move in the first direction D1 or the second direction D2 by circulation of the ball member B along the ball rail.

The bolt head 420 may be disposed between the bolt body 410 and the piston 200. The bolt head 420 may be formed to have roughly a circular cross-section. The bolt head 420 may be inserted into the piston body 210. The bolt head 420 may be disposed to face the inner surface of the piston body 210 by being spaced apart a set distance from the same.

The bolt head 420 may press the piston body 210. The bolt head 420 may press the piston body 210 in the first direction D1 or release the pressure applied to the piston body 210 depending on a direction of movement of the bolt body 410.

The bolt head 420 may be provided on one side (the left side in FIG. 9) of the bolt body 410 disposed to face the piston 200. The bolt head 420 may be formed separately from the bolt body 410 and integrated with the bolt head 420 by coupling, or may be integrally formed with the bolt body 410.

A diameter of the bolt head 420 may be formed larger than a diameter of the bolt body 410. An outer diameter of the bolt head 420 may be formed larger than an inner diameter of the nut screw 300. Accordingly, the bolt head 420 may protrude from the nut screw 300. Of course, a diameter of the bolt head 420 may be formed to be equal to or smaller than a diameter of the bolt body 410.

As the bolt body 410 moves in the direction D1, the bolt head 420 may come into contact with the inner surface of the piston body 210, and may press the piston body 210 in the first direction D1. As the bolt body 410 moves in the second direction D2, the bolt head 420 may be separated from the inner surface of the piston body 210, and may release the pressure applied to the piston body 210.

The third interference portion 430 may be provided on the outer peripheral surface of the bolt head 420. The third interference portion 430 may come into contact with the first interference portion 220. The third interference portion 430 may interfere with the first interference portion 220.

The third interference portion 430 may be formed as a flat surface to correspond to the first interference portion 220. The third interference portion 430 may be formed as a flat surface by cutting off a portion of the outer peripheral surface of the bolt head 420.

The third interference portion 430 may come into surface contact with the first interference portion 220. In another embodiment, if the first interference portion 220 has a concave shape, the third interference portion 430 may also be formed to protrude from the outer peripheral surface of the bolt head 420.

A plurality of the third interference portions 430 may be provided. The plurality of the third interference portions 430 may be disposed to be spaced apart from each other along the circumferential direction of the bolt head 420. For example, a pair of the third interference portions 430 may be disposed to face each other.

The pair of the third interference portions 430 may be disposed on both sides of the bolt head 420. To be more specific, the pair of the third interference portions 430 may be disposed at the 3 o'clock and 9 o'clock positions of the bolt head 420, respectively, when the bolt head 420 is viewed from the front. That is, the third interference portion 430 may be disposed at a location corresponding to the first interference portion 220. Since the third interference portion 430 interferes with the first interference portion 220, axial rotation of the bolt screw 400 may be restricted.

The bolt head 420 according to the present embodiment may further be provided with a pressing portion 421 coming into contact with the inner surface of the piston body 210.

The pressing portion 421 may be formed to protrude from the bolt head 420. The pressing portion 421 may protrude from the outer peripheral surface of the bolt head 420, and may be formed along the circumferential direction of the bolt head 420.

The pressing portion 421 may be provided on one side (the left side in FIG. 10) of the bolt head 420 oriented toward a direction in which the piston 200 is located.

The brake apparatus for a vehicle according to the second embodiment may include the retainer 500. The retainer 500 may be secured to the cylinder 130. The retainer 500 may interfere with the piston 200 to restrict rotation of the piston 200. The piston 200 may interfere with the retainer 500 to restrict axial rotation of the piston 200. The retainer 500 may include a metal material.

The retainer 500 may include the retainer body 510 and the damper 530.

The retainer body 510 may be formed in a ring shape. The retainer body 510 may be disposed between the cylinder 130 and the piston 200. The retainer body 510 may be interposed between the inner surface of the cylinder 130 and the outer peripheral surface of the piston body 210.

The retainer body 510 may be secured to the cylinder 130 in a way that the retainer body 510 is secured to the inner surface of the cylinder 130 by a coupling method such as bolting or pin coupling, and may be secured to the cylinder 130 in a way that the retainer body 510 is secured inside the cylinder 130 by an assembly method such as press-fitting or serration press-fitting.

The retainer 500 may further include a fourth interference portion 520 (see FIG. 6) provided on the inner peripheral surface of the retainer body 510. The fourth interference portion may come into contact with the second interference portion 230. The fourth interference portion may interfere with the second interference portion 230.

The fourth interference portion may be formed to protrude from the inner peripheral surface of the retainer body 510. The fourth interference portion may be formed to have roughly a protrusion shape. The fourth interference portion may extend, with a set thickness, from the inner peripheral surface of the retainer body 510 toward the central portion of the retainer body 510. The fourth interference portion may be accommodated in the second interference portion 230 to be seated inside the second interference portion 230. In another embodiment, if the second interference portion 230 has a convex shape, the fourth interference portion may also be formed to be recessed in the inner peripheral surface of the retainer body 510.

A plurality of the fourth interference portions may be provided. The plurality of the fourth interference portions may be disposed to be spaced apart from each other along the circumferential direction of the retainer body 510. For example, a pair of the fourth interference portions may be disposed to face each other. The pair of the fourth interference portions may be disposed on both sides of the retainer body 510. To be more specific, the pair of the fourth interference portions may be disposed at the 3 o'clock and 9 o'clock positions of the retainer body 510, when the retainer body 510 is viewed from the front. That is, the fourth interference portion may be disposed at a location corresponding to the second interference portion 230.

Since the retainer body 510 is secured to the cylinder 130, and the fourth interference portion interferes with the second interference portion 230, axial rotation of the piston 200 may be restricted. Since the axial rotation of the piston 200 is restricted, axial rotation of the bolt screw 400 may be restricted.

Since the fourth interference portion is seated inside the second interference portion 230, the linear movement of the piston 200 moving in the first direction D1 or the second direction D2 may be guided.

The damper 530 may be coupled to the retainer body 510. The damper 530 may be configured to surround the retainer body 510. The damper 530 may come into contact with the piston 200.

The damper 530 may be disposed between the retainer body 510 and the piston 200. The damper 530 may be disposed between the inner peripheral surface of the retainer body 510 and the outer peripheral surface of the piston body 210. The damper 530 may come into close contact with the piston body 210.

The damper 530 may include an elastically deformable material. For example, the damper 530 may be made of a rubber material. The damper 530 may be integrally provided with the retainer body 510. The damper 530 may be insert-molded into the retainer 500. The fourth interference portion may protrude from the damper 530.

The damper 530 may elastically support the piston 200. To be more specific, the damper 530 may elastically support the piston body 210.

The damper 530 may further be provided with the projection portion 531. The projection portion 531 may be formed to protrude from the outer surface of the damper 530 coming into contact with the piston body 210. The projection portion 531 may be seated on the piston 200. The projection portion 531 may be seated on the outer peripheral surface of the piston body 210.

A plurality of the projection portions 531 may be disposed, along a direction of a central axis of the retainer 500, to be spaced apart from each other. Here, the central axis of the retainer 500 may be located coaxially with the central axis C3 of the piston 200.

Elastic force of the projection portion 531 is applied to the piston 200 toward a central portion of the piston 200, such that the piston 200 may maintain centering. This may enable smooth linear motion of the piston 200 moving in the first direction D1 or the second direction D2, thereby ensuring the straight-line stability of the piston 200. The projection portion 531 may absorb vibrations generated when the piston 200 moves in the first direction D1 or the second direction D2, thereby reducing rattle noise.

The retainer 500 may be press-fit to the cylinder 130. A load may be applied to the retainer body 510 in the second direction D2 to press-fit the retainer body 510 into the cylinder 130. The retainer body 510 may be secured to the cylinder 130 in a way that the retainer body 510 is secured inside the cylinder 130 by an assembly method such as press-fitting or serration press-fitting, and may be secured to the cylinder 130 in a way that the retainer body 510 is secured to the inner surface of the cylinder 130 by a coupling method such as bolting or pin coupling.

In the brake apparatus for a vehicle according to embodiments of the present disclosure, the second interference portion 230 formed on the piston 200 interferes with the fourth interference portion formed on the retainer 500, thereby preventing rotation of the piston 200; and the third interference portion 430 formed on the bolt head 420 interferes with the first interference portion 220 formed on the piston 200, thereby preventing rotation of the bolt screw 400.

In the brake apparatus for a vehicle according to embodiments of the present disclosure, elastic force of the projection portion 531 formed on the damper 530 is applied to the piston 200 toward the central portion of the piston 200, thereby maintaining centering of the piston 200.

In the brake apparatus for a vehicle according to embodiments of the present disclosure, the piston boot may seal between the cylinder and the piston, thereby blocking liquid or foreign substances from entering the interior of the cylinder.

Although the present disclosure has been described with reference to the embodiments illustrated in the drawings, the embodiments are merely for illustrative purposes, and those skilled in the art will appreciate that various modifications and other equivalent embodiments are possible from the embodiments. Therefore, the true technical scope of the present disclosure should be defined by the following claims.

What is claimed is:

1. A brake apparatus for a vehicle, the brake apparatus comprising:
a caliper body provided with a cylinder;
a nut screw rotatably disposed in the cylinder;
a bolt screw movable in a first direction or in a second direction opposite to the first direction in conjunction with rotation of the nut screw;
a piston movably disposed in the cylinder and configured to move in the first direction by pressing of the bolt screw and interfere with the bolt screw to restrict rotation of the bolt screw;
a retainer secured to the cylinder and configured to interfere with the piston to restrict rotation of the piston; and
a piston boot installed between the cylinder and the piston to prevent foreign substances from entering an interior of the cylinder, and integrally formed with the retainer.

2. The brake apparatus of claim 1, wherein the piston comprises:
a piston body into which the bolt screw is inserted;
a first interference portion provided on an inner peripheral surface of the piston body and configured to interfere with the bolt screw; and
a second interference portion provided on an outer peripheral surface of the piston body and configured to interfere with the retainer.

3. The brake apparatus of claim 2, wherein:
the first interference portion protrudes from the inner peripheral surface of the piston body, and
the second interference portion is recessed in the outer peripheral surface of the piston body and extends along a direction of a central axis of the piston.

4. The brake apparatus of claim 2, wherein the bolt screw comprises:
a bolt body coupled to the nut screw by means of a ball member;
a bolt head configured to press the piston body; and
a third interference portion provided on an outer peripheral surface of the bolt head and capable of coming into contact with the first interference portion.

5. The brake apparatus of claim 4, wherein the third interference portion is formed as a flat surface by cutting off a portion of the outer peripheral surface of the bolt head.

6. The brake apparatus of claim 2, wherein the retainer comprises:
a retainer body, in a ring shape, disposed between the cylinder and the piston; and
a fourth interference portion provided on an inner peripheral surface of the retainer body and capable of coming into contact with the second interference portion.

7. The brake apparatus of claim 6, wherein the fourth interference portion protrudes from the inner peripheral surface of the retainer body.

8. The brake apparatus of claim 6, wherein the retainer further comprises a damper coupled to the retainer body and capable of coming into contact with the piston.

9. The brake apparatus of claim 8, wherein the piston boot is integrally formed with the damper.

10. The brake apparatus of claim 9, wherein the damper further comprises a projection portion seated on the piston.

11. A brake apparatus for a vehicle, the brake apparatus comprising:
a caliper body provided with a cylinder;
a nut screw rotatably disposed in the cylinder;
a bolt screw configured to reciprocate within the cylinder in conjunction with rotation of the nut screw;
a piston movably disposed in the cylinder and configured to move by pressing of the bolt screw to move a brake pad toward a brake disc; and
a piston boot disposed between the cylinder and the piston to prevent foreign substances or liquid from entering an interior of the cylinder, and interference-fit to each of the cylinder and the piston.

12. The brake apparatus of claim 11, wherein:
the piston boot is ring shaped, and
the piston boot comprises:
an outer boot portion configured to accommodate a first metal insert, and interference-fit to an inner wall of the cylinder;
an inner boot portion configured to accommodate a second metal insert, and interference-fit to an outer wall of the piston; and
a connecting boot portion configured to connect the outer boot portion and the inner boot portion.

13. The brake apparatus of claim 12, wherein the outer boot portion, the inner boot portion, and the connecting boot portion are integrally formed, and are made of a rubber material.

14. The brake apparatus of claim 12, wherein:
the first metal insert is inserted into and integrated with the outer boot portion by insert injection-molding, and
the second metal insert is inserted into and integrated with the inner boot portion by insert injection-molding.

15. The brake apparatus of claim 14, wherein:
the first metal insert and the second metal insert are each formed in a ring shape, and a diameter of the first metal insert is larger than a diameter of the second metal insert, and
at least one of the first metal insert or the second metal insert has a cross section that is a rectangular shape or L-shape.

16. The brake apparatus of claim 12, wherein the connecting boot portion has an accordion shaped cross-section and is elastically deformable.

17. The brake apparatus of claim 12, further comprising a retainer secured to the cylinder and configured to interfere with the piston to restrict rotation of the piston,
wherein the outer boot portion is disposed such that an outer surface of the outer boot portion comes into contact with the inner wall of the cylinder, and a side surface of the outer boot portion comes into contact with the retainer.

18. The brake apparatus of claim 12, wherein the outer boot portion is provided with one or more outer projections configured to protrude outward from a portion opposing the inner wall of the cylinder.

19. The brake apparatus of claim 12, wherein the inner boot portion is provided with one or more inner projections configured to protrude inward from a portion opposing the outer wall of the piston.
